(19) United States
(12) Patent Application Publication
(10) Pub. No.: US 2007/0041048 A1
(43) Pub. Date: Feb. 22, 2007

(54) Network system, data processing device, and data transmission device

(75) Inventor: Masashi Suzuki, Nagoya (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/505,819

(22) Filed: Aug. 18, 2006

(30) Foreign Application Priority Data
Aug. 19, 2005 (JP) 2005-239086

(51) Int. Cl. G06F 3/12

(52) U.S. Cl. 358/1.15; 358/402

(57) ABSTRACT

A network system comprising a data processing device with a communication circuit connected to a telecommunication line, and a communication device internally communicably connected to the data processing device via a network is provided. The data processing device is provided with a receiver system to receive mail data transmitted from a data transmitting device via the communication circuit and a transferring system to internally communicate with the communication device to transfer the mail data transmitted from the receiver system to the communication device via the network.

### CROSS REFERENCE TO RELATED APPLICATION

This application claims priority from Japanese Patent Application No.2005-239086, filed on Aug. 19, 2005, the entire subject matter of which is incorporated herein by reference.

### BACKGROUND

1. Technical Field

Aspects of the invention relate to a network system having a plurality of terminal devices connected with each other through communication lines.

2. Related Art

Conventionally, network systems with a plurality of terminal devices connected with each other through communication lines are known. In such networks, for example, computers, PCs (personal computers), workstations, telephones, and facsimile machines are used as terminal devices, and data is generally exchanged in a circuit switching mode and a store and forward mode.

In the circuit switching mode, when data is exchanged between two terminal devices, an intervenient switch in the network provides connection to the two terminal devices so that the two terminal devices are exclusively connected. The circuit switching mode is employed in public telephone networks, for example. Facsimile transmission is generally executed in the circuit switching mode, in which a facsimile machine as a sender and a facsimile machine as a receiver are connected on one-to-one basis via the public telephone network, therefore it is less likely that the data transmitted between the facsimile machines in the public telecommunication line is undesirably copied and falsified.

In the store and forward mode, data sent from a terminal device as a sender is temporarily stored in a memory device equipped to a server, divided and appended additional information indicating for example an address of the data to be sent so that the data is divisionally sent to the addressee. The store and forward mode is widely employed in computer networks such as the Internet. E-mail transmission is generally executed in the store and forward mode. E-mail data created in a PC is sent to another PC as a receiver via the Internet, and content indicated by the e-mail data is displayed in a window generated in e-mail application software. As the e-mail data is exchanged between PCs as the terminal devices, the e-mail data can be advantageously reused in the terminal devices.

The e-mail data sent from the sender PC is once received by a mail server of an internet provider to which a user of the sender PC subscribes and passed through a plurality of mail servers provided on the Internet before a mail server of an internet provider to which a user of the addressee PC subscribes receives the same. Thus, it is possible that the e-mail data is undesirably copied and falsified in the plurality of mail servers as the e-mail data passes therethrough. Therefore, in many cases, information with a significant content is output on paper to be sent by the facsimile machines. However, the information received by the facsimile machine is transmitted as image data and is not capable of being used as suitable data in PCs and the like. In consideration of the disadvantage, an internet facsimile machine that is connected with the public telecommunication line and the Internet so that the data with the significant content can be encrypted before being transmission when the data is sent via the Internet so that the data is secured. In a facsimile transfer device 110 disclosed in Japanese Patent Provisional Publications No. 2001-298576, data for the facsimile machine is encrypted and transmitted via the Internet. FIG. 9 shows a block diagram to illustrate an internal configuration of the facsimile transfer device 110 of the prior art.

In the facsimile transfer device 110, processing condition information including a password, an encryption method and the like that has been configured at a notification destination is stored in an HDD (hard disk drive) 114. As the facsimile transfer device 110 executes a program stored in a ROM 112, facsimile data received in a facsimile I/F (interface) 118 trough the public telecommunication line is stored in a RAM 113. Then, as destination information accompanied with the facsimile data is received, the processing condition information for the destination information is specified so that the facsimile data can be processed according to the processing condition information.

The processed facsimile data is thereafter transmitted from a network I/F 117 to a mail server of an internet provider to which a user of the destination PC subscribes via the Internet and stored therein. The facsimile data stored in the mail server is further transmitted to the destination PC from the mail server when the destination PC inquires as to whether an e-mail addressed to the destination PC has been received by the mail server of the internet provider using e-mail application software. The user of the destination PC operates the destination PC to display and view the content included in the facsimile data on a display unit of the destination PC by using the processing condition information such as the password and the encryption method that has been previously configured. According to the network system with the facsimile transfer device 110, it is less likely that the facsimile data is undesirably copied and falsified in the plurality of mail servers as the facsimile data passes therethrough as the facsimile data is transmitted to the destination PC via the Internet.

In the network system with the facsimile transfer device 10, however, user at the notification destination is required processes to configure the processing condition information such as the password and the encryption method in the facsimile transfer device 110. In addition, as the facsimile transfer device 10 requires software for processing notification to be installed therein, additional cost for configuring the system is required. Therefore, users who are concerned about cost for configuring the system and managing security of the network system may still wish to transmit the facsimile data via the public telecommunication line on the one-to-one basis.

### SUMMARY OF THE INVENTION

In view of the foregoing drawbacks, aspects of the present invention are advantageous in that a network system, a data processing device, and a data transmitting device capable of managing security for e-mail data in a less complicated manner and cost-effectively without modifying a configuration of a communication device are provided.

### BRIEF DESCRIPTION OF THE ACCOMPANYING DRAWINGS

FIG. 1 shows a diagram to illustrate a network system according to a first embodiment of the invention.

FIG. 2 shows a block diagram to illustrate an intranet at a destination side according to the first embodiment of the invention.

FIG. 3 shows a block diagram to illustrate an intranet at a sender side according to the first embodiment of the invention.

FIG. 4 shows a flowchart to illustrate data transmission process according to the first embodiment of the invention.

FIG. 5 shows a flowchart to illustrate data transfer process according to the first embodiment of the invention.

FIG. 6 shows a flowchart to illustrate error information transmission process executed by a mail server according to the first embodiment of the invention.

FIG. 7 shows a diagram to illustrate a network system according to a second embodiment of the invention..

FIG. 8 shows a flowchart to illustrate data transfer process in the network system according to the second embodiment of the invention.

FIG. 9 shows a block diagram to illustrate an internal configuration of the facsimile transfer device of a prior art.

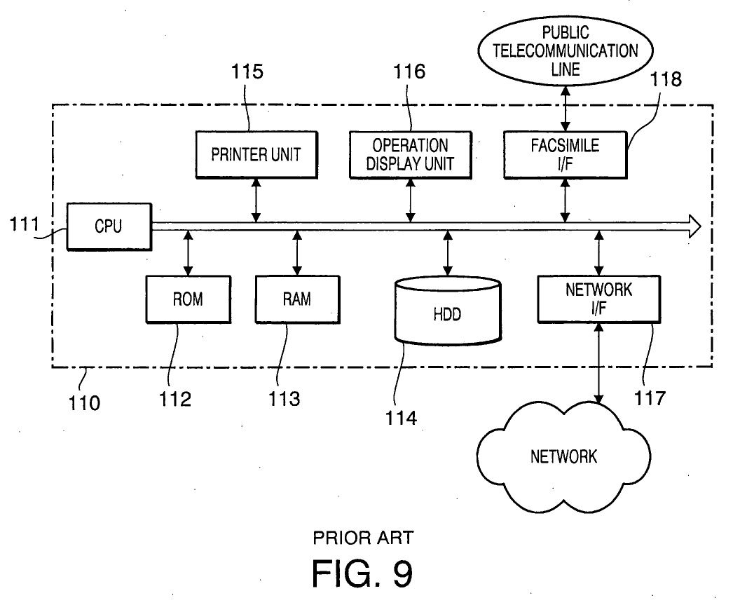

### DETAILED DESCRIPTION

General Overview of Aspects of the Invention

The following describes general aspects of the invention that may or may not be comprised in various embodiments and modifications. It should be noted that various connections are set forth between elements in the following description. These connections, in general and, unless specified otherwise, may be direct or indirect and this specification is not intended to be limiting in this respect.

According to some aspects of the invention, there is provided a network system comprising a data processing device with a communication circuit connected to a telecommunication line, and a communication device internally communicably connected to the data processing device via a network. The data processing device is provided with a receiver system to receive mail data transmitted from a data transmitting device via the communication circuit. A transferring system to internally communicate with the communication device to transfer the mail data transmitted from the receiver system to the communication device via the network.

According to the network system with the above configuration, as the data transmitting device transmits the mail data via the telecommunication line, the mail data is transferred to the communication device via the data processing device. The data processing device receives the mail data from the telecommunication line in the receiver system so that the received mail data are internally communicable to be transferred to the communication system via the network. It should be noted that “internally communicable” refers to capability of communicating within a network that is protected by a security system. In the network system with the above configuration, the data processing device is connected with the data transmitting device via the telecommunication line on one-to-one basis to receive the mail data, which is further internally transferred to the communication device via the network. Thus, the mail data can be securely transmitted to the data transmitting device to the communication device.

Therefore, the mail data that may include confidential information can be transmitted securely to the communication device without having encrypting software installed in the data processing device and managing an or setting passwords in the data processing device, and security of the mail data transmitted from the data processing device to the communication device can be cost-effectively achieved in a less complicated manner without modifying a configuration of an existing data processing device.

Optionally, the network system may further comprise a mail server which is internally communicably connected with the data processing device and the communication device via the network. The transferring system may transfer the mail data to the communication device via the mail server.

According to the above configuration, the mail server is internally communicably connected to the data processing device so that the mail data received in the data processing device is stored in the mail server and transferred to the communication device. Thus, the data processing device is not required to store a large amount of mail data therein.

Optionally, the mail server may be provided with a transmission system which transmits error information to the data processing device when the transferring system fails in transferring the mail data to the communication device. The data processing device may be provided with a network interface, which connects the data processing device with the Internet, a return data generating system, which generates return mail data by removing message data from the mail data received by the receiver system and adding an error notifying message when the error information is received by the data processing device, and a returning system, which returns the return mail data generated by the return data generating system to the data transmitting device that transmitted the mail device via the Internet.

According to the above configuration, the error information is transmitted from the mail server to the data processing device when transferring the mail data to the data processing device to the communication device fails. In this event, the data processing device that received the error information creates return mail data by removing the message data from the mail data and replacing the message data with the error notifying message so that the return mail data can be transmitted via the Internet to the data transmitting device that has sent the mail data via the telecommunication line. Thus, the failure in transmitting the mail data to the communication device can be notified while the message of the mail data is prevented from leakage.

Optionally, the receiver system may be provided with a function as a mail server. The transferring system may transfer the mail data transmitted from the receiver system to the communication device via the network.

According to the above configuration, the data processing device comprises the function as a mail server. Therefore, when the mail data is internally transferred to the communication device via the network, the mail data to be received by the communication device can be processed within one data processing device so that the network system can be provided in a smaller configuration.

Optionally, the data processing device may be provided with a network interface, which connects the data processing device with the Internet, a return data generating system, which generate return mail data by removing message data from the mail data received by the receiver system and adding an error notifying message when the transferring system fails in transferring the mail data to the communication device, and a returning system, which returns the return mail data generated by the return data generating system to the data transmitting device that transmitted the mail device via the Internet.

According to the above configuration, the data processing device is connected with the Internet via the network interface so that the return mail data can be generated by removing the message data from the mail data and replacing the message data with the error notifying message and returned to the data transmitting device that has sent the mail data via the telecommunication line to the communication device. Thus, the failure in transmitting the mail data to the communication device can be notified while the message of the mail data is prevented from leakage.

Optionally, the data processing device may be provided with a domain address storing unit, in which a domain address of the data processing device is stored, a judging system, which obtains a domain address of the communication device as a destination from the mail data received by the receiver system and determines as to whether the domain address of the communication device as the destination corresponds to the domain address of the data processing device stored in the domain address storing unit, and a prohibiting system, which prohibits the transferring system to transfer the mail data to the communication device when the judging system determines that the domain address of the communication device as the destination does not correspond to the domain address of the data processing device.

According to the above configuration, the data processing device obtains the domain address of the communication device as the destination of the mail data transmitted from the receiver system and determines as to whether the domain address of the communication device as the destination correspond to the domain address of the data processing device. When the two domain addresses do not correspond, the communication to receive the mail data is not connected to the data processing device. Therefore, the data processing device is prohibited from transferring the mail data to the communication device. Thus, the mail data can be prevented from being improperly transferred to the communication device so that the security for transmitting the mail data that may include confidential information can be improved.

According to another aspects of the invention, there is provided a data processing device connected to a communication device via a network, comprising a communication circuit, which is connected to a telecommunication line and converts data, a receiver system, which receives mail data transmitted from a data transmitting device via the communication circuit, and a transferring system, which internally communicates with the communication device to transfer the mail data transmitted from the receiver system to the communication device via the network.

According to the above configuration, the data processing device converts the mail data inputted from the telecommunication line via the communication circuit in a suitable form to be received by the receiver system so that the mail data is internally transferred to the communication device through the network. In the network system with the above configuration, the data processing device is connected with the data transmitting device via the telecommunication line on one-to-one basis to receive the mail data, which is further internally transferred to the communication device via the network. Thus, the mail data can be securely transmitted to the data transmitting device to the communication device. Therefore, the mail data that may include confidential information can be transmitted securely to the communication device without having encrypting software installed in the data processing device and managing an or setting passwords in the data processing device, and security of the mail data transmitted from the data processing device to the communication device can be cost-effectively achieved in a less complicated manner without modifying a configuration of an existing data processing device.

According to another aspects of the invention, there is provided a data transmitting device, comprising a storing unit, in which a mail address identifying a communication device as a destination of mail data and a number sequence identifying a data processing device whereto the mail data is transmitted via a telecommunication line are associated with each other to be stored therein, a specifying system, wherein the mail address as the destination to transmit the mail data is specified, a number sequence obtaining system, which obtains the number sequence corresponding to the mail address specified in the specifying system, and a mail data transmission system, which transmits the mail data to the communication device via the data processing device being identified by the number sequence obtained by the number sequence obtaining system.

According to the above configuration, in the data transmitting device, the mail address identifying the communication device as the destination of the mail data and the number sequence identifying the data processing device whereto the mail data is transmitted are associated with each other so that the number sequence associated with the mail address is obtained when the mail address is specified by a user, and the mail data can be transmitted to the communication device via the data processing device corresponding to the obtained number sequence. Therefore, the data transmitting device connected to the communication device via the telecommunication line on one-to-one basis, and the mail data can be securely transmitted to the communication device without having the user to input the number sequence of the data processing device. Thus, security of the mail data transmitted from the data processing device to the communication device can be cost-effectively achieved in a less complicated manner without modifying a configuration of an existing data processing device.

Optionally, the data transmitting device may further comprise a confidentiality specifying system, which is communicable with the communication device via the Internet and in which confidentiality of the mail data is specified. The mail data transmission system transmits the mail data to the communication device via the data processing device when the mail data is specified to contain confidential information in the confidentiality specifying system and transmits the mail data to the communication device via the Internet when the mail data is specified not to contain confidential information in the confidentiality specifying system.

According to the above configuration, the data transmitting device is connected to the communication device via the Internet. In this configuration, when the mail data to be transmitted to the communication device contains confidential information, the mail data is transmitted through the telecommunication line. When the mail data to be transmitted to the communication device does not contain specific confidential information, on the other hand, the mail data is transmitted to the communication device through the Internet. Thus, an amount of the mail data to be transferred from the data processing device to the communication device can be reduced so that communication load on the data processing device can be reduced.

### Embodiment

Hereinafter referring to the accompanying drawings, a network system, a data processing device, and a data transmission device according to a first embodiment of the invention will be described.

### First Embodiment

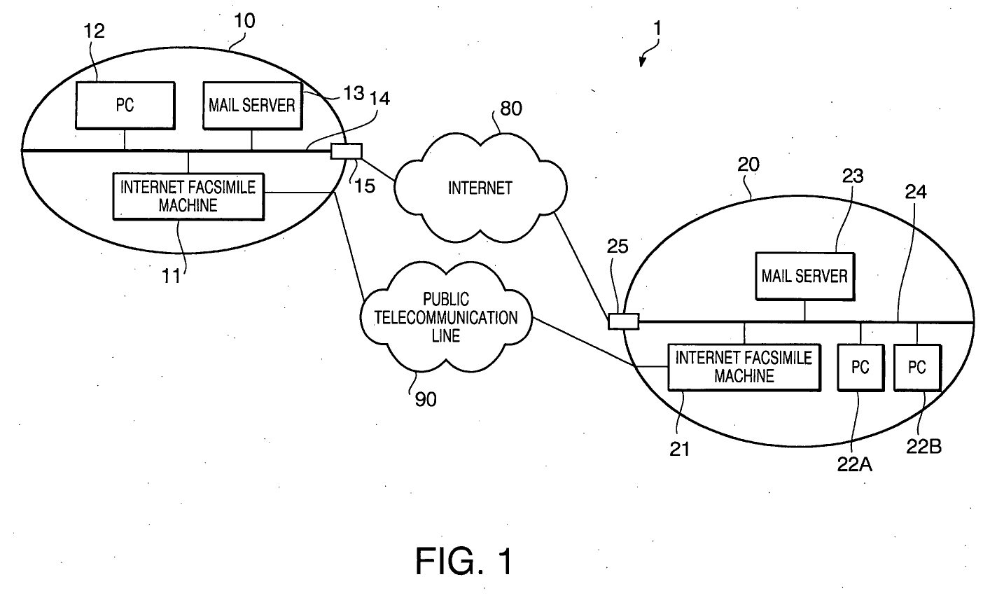

A configuration of a network system 1 according to the first embodiment will be described. FIG. 1 shows a diagram to illustrate the network system 1 according to a first embodiment of the invention. The network system 1 includes intranets 10, 20 which are connected with each other via the Internet 80 and a public telecommunication line 90. As the intranets 10, 20 are interconnected with the Internet 80 and the public telecommunication line 90, various data including audio data, document data, and image data can be exchanged within the network system 1. In the present embodiment, it is assumed that a company employee α of a company A transmits mail data including confidential information to a company employee β of a company B as an example. It is further assumed that the company A is equipped with the internet 10 while the company B is equipped with the intranet 20.

The intranet 10 in the company A includes an internet facsimile machine 11, a PC 12, and a mail server 13, which are interconnected via a connection cable 14. Between the Internet 80 and the connection cable 14, a firewall 15 is provided so that the internet facsimile machine 11, the PC 12, and the mail server 13 are connected to be internally communicable within a secure internal network protected by the firewall 15.

The intranet 20 in the company B includes an internet facsimile machine 21, PCs 22A, 22B, and a mail server 23, which are interconnected via a connection cable 24. Between the Internet 80 and the connection cable 24, a firewall 25 is provided so that the internet facsimile machine 21, the PCs 22A, 22B, and the mail server 23 are connected to be internally communicable within a secure internal network protected by the firewall 25. In the present embodiment, “internally communicable” refers to capability of communicating within a network (i.e., the intranets 10, 20) that is secured by the firewalls 15, 25.

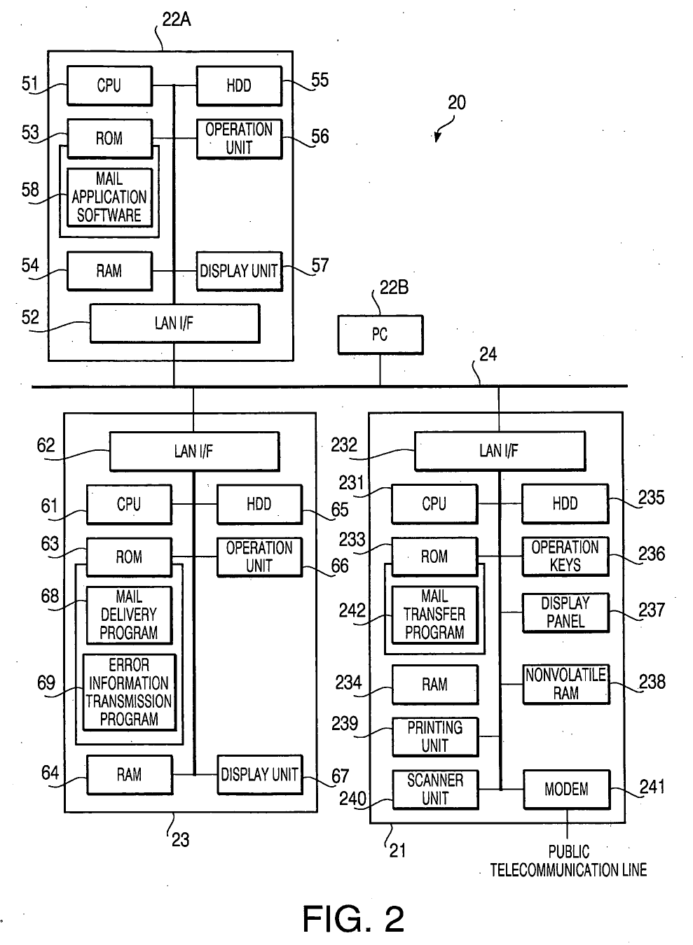

Hereinafter, the intranet 20 at a destination side according to the first embodiment will be described. FIG. 2 shows a block diagram to illustrate the intranet 20 at the destination side according to the first embodiment of the invention. The internet facsimile machine 21, connected to the internet 80 and the public telecommunication line 90, is an MFP (multifunction peripheral) having a plurality of functions such as a printing function, a scanning function, a copying function, a facsimile transmission/reproduction function, and a mailing function. The internet facsimile machine 21 includes a LAN I/F (interface) 232, a ROM 233, a RAM 234, an HDD 235, operation keys 236, a display panel 237, a nonvolatile RAM 238, a printing unit 239, a scanning unit 240, and a modem 241, which are respectively connected to a CPU (central processing unit) 231.

The CPU 231 controls operations of each units of the internet facsimile machine 21 and calculation of various data. The LAN I/F 232 exchanges data with other terminal devices, i.e., the PCs 22A, 22B, the mail server 23 via the connection cable 24. Further, the LAN I/F 232 is connected to the Internet 80 via the connection cable 24 (see FIG. 1), so that e-mail transmission/reception and access to other Internet sites (i.e., web sites) can be achieved. In other words, the LAN I/F 232 also serves as an Internet I/F of the internet facsimile machine 21.

The ROM 233 stores various programs therein. In the present embodiment, for example, a mail transfer program 42 is stored in the ROM 233.

The mail transfer program 42 receives mail data via the modem 241, which will be described later, and stores the same in the HDD 35. Further, the mail transfer program 42 reads the received mail data from the HDD 235 and transfers to the internally communicable PCs 22A, 22B via the connection cable 24. It should be noted that the mail data can be converted by the modem 41 if necessary to be stored in the HDD 235, or may be stored unconverted in the HDD 235.

In the present embodiment, the mail data includes confidentiality information, message data, title data, addressee information, sender information. The confidentiality information indicates confidentiality (confidential or normal) of the mail. The message data, complied with SMTP (Simple Mail Transfer Protocol), being a commonly used mail transfer protocol, indicates a content of a message (including documents and images) that a sender intends to provide to an addressee. The title data indicates a title of the message. The addressee information indicates a destination address of an addressee of the mail data. The sender information indicates an address of a sender of the mail data.

The mail transfer program 42 creates return data, which is returned to a data transmission device that has transmitted mail data via the Internet 80 when the mail server 23 fails to transfer the mail data to the PCs 22A, 22B. Further, the mail transfer program 42 examines as to whether a domain address of the internet facsimile machine 21 corresponds to a domain address of the destination address included in the mail data. When the two domain addresses do not correspond, the mail transfer program 42 prohibits transferring the mail data to the PCs 22A, 22B.

The RAM 234 temporarily stores data therein as the CPU 231 processes various data. The HDD 235 stores data inputted from an external source therein. The operation keys 236 includes an operation button (not shown), a touch-sensitive panel (not shown), and an operation stick (not shown), which are operated by a user of the internet facsimile machine 21. The data processed by the CPU 231 is displayed in the display panel 237, while the touch-sensitive panel can be also displayed in the display panel 237.

The nonvolatile RAM 238 therein stores data which should not be deleted even when the internet facsimile machine 21 is powered off. In the present embodiment, the domain address of the internet facsimile machine 21 is stored in the nonvolatile RAM 238 of the internet facsimile machine 21 as the destination.

The printing unit 239 forms images indicated by data such as the facsimile data, image data, and document data on a recording medium such as paper and an OHP (overhead projector) film. The scanner unit 240 scans an original image recorded on a recording medium such as paper and reads data recorded in a recording medium such as a CD and a memory stick. The modem 241 is connected to the public telecommunication line 90 so that analog audio data can be converted into suitable data, and vice versa.

The PCs 22A, 22B are known computers, which are respectively provided to employees of the company B. As the PCs 22A, 22B are configured similarly, merely the PC 22A, which is used by the employee β, is explained, and a configuration of the PC 22B is omitted. The PC 22A includes a LAN I/F 52, a ROM 53, a RAM 54, an HDD 55, an operation unit 56, a display unit 57, which are respectively connected to a CPU 51. The PC 22A stores mail application software 58 in the ROM 53. The mail application software 58 inquires the mail server 23 for mail data when the user inputs an operation to inquire for mail data via the operation unit 56 such as a keyboard and at a predetermined interval. When the mail data has been received by the mail server 23, the mail application software 58 obtains and stores the same in the HDD 55 so that the mail data is displayed on a display panel (not shown) in the display unit 57.

The mail server 23 is a known computer having a LAN I/F 62, a ROM 63, a RAM 64, an HDD 65, an operation unit 66, and a display unit 67, which are respectively connected with a CPU 61. The mail server 23 stores mail delivery program 68 in the ROM 63. The mail server 23 stores the mail data, for example, addressed to the PCs 22A, 22B and transferred from the internet facsimile machine 21 in the HDD 65. As the PCs 22A, 22B inquire the mail server 23 for mail data, the mail delivery program 68 transfers the mail data to the PCs 22A, 22B when the destination address of the mail data corresponds to addresses of the PCs 22A, 22B. The mail server 23 further stores error information transmission program 69 in the ROM 63. When transfer of the mail data to the PCs 22A, 22B fails, the error information transmission program 69 transmits information concerning the error to the internet facsimile machine 21.

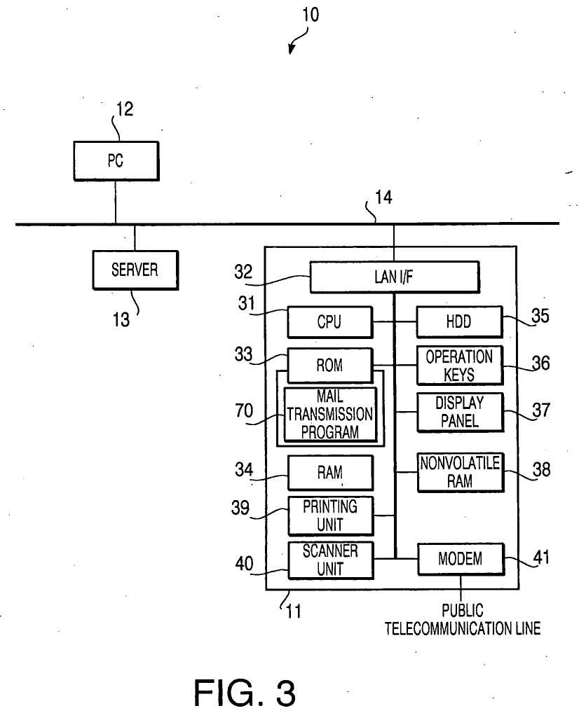

Hereinafter, the intranet 10 at a sender side according to the first embodiment will be described. FIG. 3 shows a block diagram to illustrate the intranet 10 at the sender side according to the first embodiment of the invention. The intranet 10 in the company A includes the internet facsimile machine 11, the PC 12, and the mail server 13, which are interconnected via the connection cable 14 to be internally communicable to each other. The internet facsimile machine 11, the PC 12, and the mail server 13 are in similar configurations to the configurations of the internet facsimile machine 21, the PCs 22A, 22B, and the mail server 23 in the intranet 20 at the destination side, therefore description of those in the similar configurations is omitted. It should be noted that components of the internet facsimile machine 21 that are similar to those of the internet facsimile machine 11 are provided with reference numerals including last two digits equivalent to the reference numerals of the corresponding components of the internet facsimile machine 11.

The nonvolatile RAM 38 therein stores data which should not be deleted even when the internet facsimile machine 21 is powered off. In the present embodiment, for example, a destination mail address that specifies a communication device as a destination and a telephone number of a data processing device that is connected with the internally communicable communication device as the destination are associated with each other and stored in the nonvolatile RAM 38.

The internet facsimile machine 11 stores mail transmission program 70 in the ROM 33. The mail transmission program 70 obtains the telephone number corresponding to the mail address of the destination, which is selected by an operation from a user, from the nonvolatile RAM 38. The mail transmission program 70 thereafter transmits the mail data to the communication device as the destination via the data processing device that is assigned the obtained telephone number.

The mail transmission program 70 determines as to whether confidentiality of the mail data to be transmitted is confidential or normal. When the mail data is determined to be confidential, the mail transmission program 70 transmits the mail data to the communication device such as a PC as the destination via the public telecommunication line 90, while the mail data is transmitted to the communication device as the destination via the Internet 80 when confidentiality of the mail data is determined to be normal. In the present embodiment, the mail data with confidentiality is referred to as confidential mail data, while the mail data with normal confidentiality is referred to as normal mail data. The user specifies the mail data to be confidential mail data when the mail data should be securely transmitted. When the mail data should be transmitted with no specific security, the mail data is specified to be the normal mail data. In the present embodiment, determination as to whether the mail data is the confidential mail data or the normal mail data is made when the mail data is created.

As the internet facsimile machine 11 of the present embodiment use the public communication line 80 to transmit the mail data, the internet facsimile machine 11 is configured to transmit a telephone number that specifies a data processing device and a communication protocol that is required for communicating with the data processing device as well as the mail data to the public communication line 90.

Hereinafter, communication processes executed in the network system 1 will be described. In the network system 1, the internet facsimile machine 11 of the company A, the mail server 13, the internet facsimile machine 21 of the company B, and the mail server 23 are powered on at all times to be internally communicable with each other. The PC 12 of the company A and the PCs 22A, 22B of the company B are communicable and not communicable depending on power status, as the PCs 12, 22A, 22B are powered on when used and powered off when not used. In the network system 1, communication is conducted by using various hardware resources such as the conventional public telecommunication line 90, the internet facsimile machine 11, 21, the PCs 12, 22A, 22B, and the connection cable 24 so that security of the mail data transmitted therethrough can be achieved cost-effectively in a less complicated manner.

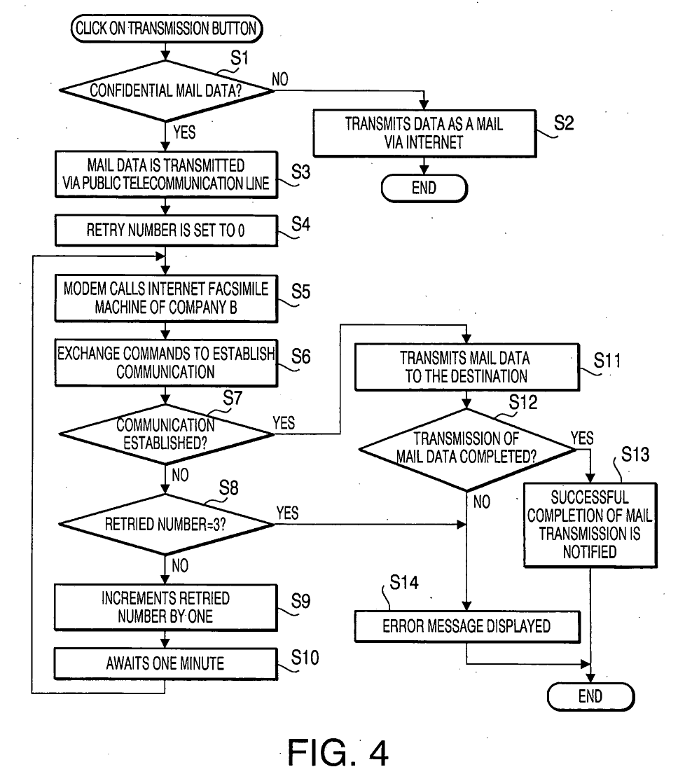

Hereinafter, the data transmission process of the network system 1 will be described. FIG. 4 shows a flowchart to illustrate the data transmission process according to the first embodiment of the invention. As the employee α creates a mail by inputting information such as the message data, the title data, the destination address, and the confidentiality information by using the operation keys 36 of the internet facsimile machine 11, the information is stored in the HDD 35 as mail data. The internet facsimile machine 11 displays a button for transmission (a transmission button) on the display panel 37 so that the employee α clicks on (presses) the transmission button by using the operation keys 36 when the employee α completes creating mail data to be transmitted. As the mail transmission program 70 is read from the ROM 33, the mail transmission process shown in FIG. 4 starts.

As the mail transmission process is started, in SI, determination is made as to whether the mail data that the employee α created is confidential mail data. As described above, the mail data includes the confidentiality information that indicates confidentiality of the mail data so that the internet facsimile machine 11 determines as to whether the mail data is confidential mail data or normal mail data based on the confidentiality information. When the confidentiality information of the mail data indicates the mail data being normal mail data (S1:NO), the process proceeds to S2, wherein the data as the mail is transmitted to the employee β of the company B via the Internet 80. The process terminates thereafter. It should be noted that, in S2, as the mail data is transmitted via the Internet 80, the mail data is primarily transmitted to the mail server 13 and thereafter transferred to other mail servers (i.e., SMTP mail servers, not shown) through the Internet 80 to be finally received by the PC 22A of the company B.

In S1, when the confidentiality information indicates the mail data is confidential mail data (SI: YES), the process proceeds to S3, wherein determination is made that the mail data is transmitted to the employee β via the public communication line 80. The process proceeds to S4. In S4, a number to retry for the modem 41 to establish connection with the PC 22A of the employee β is set to zero. In S5, the internet facsimile machine 21 is called by the modem 41 sending a telephone number of the internet facsimile machine 21 of the company B. In the HDD 35 of the internet facsimile machine 11 of the company A, the telephone number of the internet facsimile machine 21 is stored in association with the destination address. Therefore, as the employee α specifies a mail address of the employee β as the destination address, the telephone number of the internet facsimile machine 21 is automatically obtained so that the modem 41 of the internet facsimile machine 11 can attempt to establish connection with the internet facsimile machine 21.

As the connection is established between the internet facsimile machine 11 and the internet facsimile machine 21 via the public telecommunication line 90, various commands to establish communication therebetween are exchanged. In S7, determination is made as to whether the communication between the internet facsimile machine 11 and the internet facsimile machine 21 is established. When the communication is established (S7: YES), in S11, the internet facsimile machine 11 transmits the mail data to the internet facsimile machine 21 as the destination. Thereafter, in S12, it is confirmed as to whether the transmission of the mail data was successfully completed. In this step, the determination is made based on a transmission completion signal, which is transmitted from the internet facsimile machine 11 to the internet facsimile machine 21 to notify of completion of the entire mail data.

When the internet facsimile machine 11 transmits the transmission completion signal, and the completion of transmitting the mail data to the internet facsimile machine 21 is confirmed, determination is made that the transmission was successful (S12: YES). Thereafter, in S13, a message to notify the sender (i.e., the employee α) of a successful completion of the mail data is displayed in the display unit 57 of the PC 12. The process terminates thereafter.

In S12, when the internet facsimile machine 11 does not transmit the transmission completion signal to the internet facsimile machine 21, and completion of transmitting the mail data to the internet facsimile machine 21 is not confirmed, determination is made that the transmission failed (S12: NO). Thereafter, in S14, an error message to notify the employee α of the failure of the transmission is displayed in the display unit 57 of the PC 12. The process terminates thereafter.

In S7, when the internet facsimile machine 11 of the company A cannot exchange the commands with the internet facsimile machine 21 of the company B, and no communication is established (S7: NO), determination is made as to whether the number that the modem 41 retried to establish connection with the PC 22A is 3. It should be noted that in the present embodiment the number to be retried is limited to 3. If the number to be retred is unlimited, the public telecommunication line 90 remains occupied by the internet facsimile machine 11 while the internet facsimile machine 11 keeps retrying, thus the other communication devices cannot be connected with the internet facsimile machine 11 via the public telecommunication line 90. When the internet facsimile machine 11 calls the internet facsimile machine 21 for a first time, the retried number is zero (S8: NO), therefore the process proceeds to S9. In S9, the retried number is incremented by 1. Thereafter, in S10, the internet facsimile machine 11 awaits for one minute. When one minute has passed, the process returns to S5, wherein the internet facsimile machine 11 retries to establish communication with the internet facsimile machine 21.

As the commands are exchanged (S6), and when communication with the internet facsimile machine 21 is established (S7: YES), the steps following S11 are executed.

When communication between the internet facsimile machine 21 and the internet facsimile machine 11 is still not established (S7: NO), in S8, determination is made as to whether the number that the modem 41 retried to establish connection with the PC 22A is 3. When determination is made that the retried number is not 3 (S8: NO), S9 and S10 are executed as described above. Thereafter, the process returns to S5, wherein the internet facsimile machine 11 retries to establish communication with the internet facsimile machine 21.

When communication between the internet facsimile machine 11 and the internet facsimile machine 21 is not established after retrying for three times (S5, S6, S7: NO, S8: YES), the process proceeds to S14, wherein the error to notify the employee α of the failure of the transmission is displayed in the display unit 57 of the PC 12 so that the internet facsimile machine 11 can release the internet facsimile machine 11, and the other communication devices can be connected with the internet facsimile machine 11 via the public telecommunication line 90.

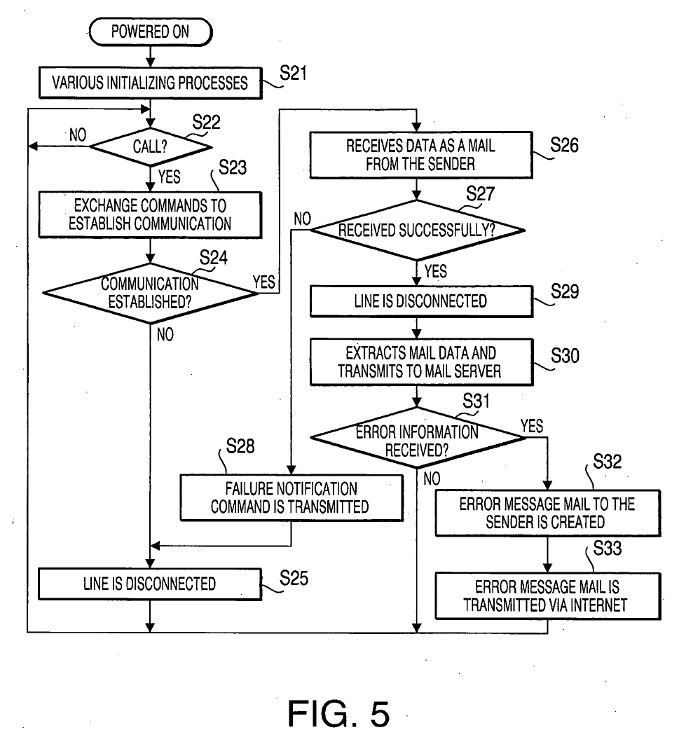

Hereinafter, a data transfer process of the internet facsimile machine 21 will be described. FIG. 5 shows a flowchart to illustrate the data transfer process according to the first embodiment of the invention. As the internet facsimile machine 21 of the company B is powered on, various initializing processes is executed in the internet facsimile machine 21 in S21. In S21, the internet facsimile machine 21, in a ready state, executes the various programs in a predetermined interval. In S22, determination is made as to whether a call is received. The determination is made that the call is not received until the internet facsimile machine 11 is connected with the internet facsimile machine 21 via the public telecommunication line 90 (S22: NO).

In S22, when the determination is made that the call is received as the internet facsimile machine 11 is connected with the internet facsimile machine 21 via the public telecommunication line 90 (S22: YES). In S23, various commands to establish communication between the internet facsimile machine 11 and the internet facsimile machine 21 are exchanged. In S24, determination is made as to whether the communication is established. When the determination is made that the communication is established (S24: YES), in S26, the mail data is received. More specifically, the data transmitted from the internet facsimile machine 11 is converted into suitable data by the modem 241 and stored in the HDD 235. The data transmitted from the internet facsimile machine 11 of the company A to the internet facsimile machine 21 of the company B includes information such as the telephone number of the internet facsimile machine 21 and the communication protocol as well as the mail data. The internet facsimile machine 21 stores the entire data in the HDD 235. In S27, determination is made as to whether reception of the entire data is successful. In this step, the determination is made based on the transmission completion signal, which is transmitted from the internet facsimile machine 11 to the internet facsimile machine 21 to notify of completion of the entire mail data.

When the internet facsimile machine 21 does not receive the transmission completion signal, and receiving the mail data to the internet facsimile machine 21 is not completed, determination is made that the transmission failed (S27: NO). In S28, a failure notification command to notify the sender of the failure of the reception is transmitted to the internet facsimile machine 11. In S25, the internet facsimile machine 21 is disconnected from the public telecommunication line 90. The error message to notify the employee α of the failure of the transmission is displayed in the display unit 57 of the PC 11.

In S27, when the internet facsimile machine 21 receives the transmission completion signal, determination is made that the transmission was successful (S27: YES). Thereafter, in S29, the public telecommunication line 90 connecting the internet facsimile machine 11 with the internet facsimile machine 21 is disconnected. In S30, the mail data is extracted from the received data that is stored in the HDD 235. The extracted mail data is transmitted to the mail server 23 of the intranet 20 via the connection cable 24. Thereafter, in S31, determination is made as to whether error information from the mail server 23 is received.

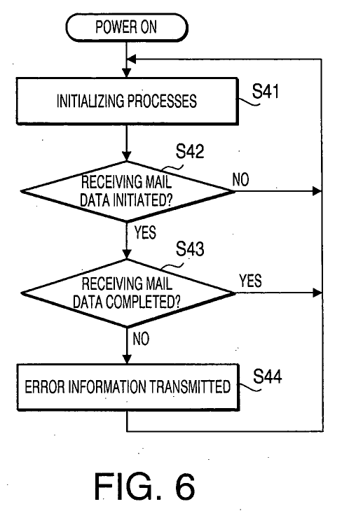

A flow of the error information in the present embodiment will be described. FIG. 6 shows a flowchart to illustrate error information transmission process executed by the mail server 23 according to the first embodiment of the invention. As the mail server 23 of the company B is powered on, the error information transmission program 69 is read from the ROM 63 and executed. In S41, the mail server 23 executes various initializing processes. In S42, determination is made as to whether the mail server 23 initiated receiving the mail data based on a transfer initiation control signal, which is included in the mail data transferred from the internet facsimile machine 21 to notify the mail server 23 of initiation of transfer. When the transfer initiation control signal is not received, determination is made that reception of the mail data has not started (S42: NO). In this state, an error such that the mail server 23 is unable to transfer the mail data to the PCs 22A, 22B is avoided, therefore, the process returns to S41.

In S42, when the transfer initiation control signal is received, determination is made that reception of the mail data has started (S42: YES). Next, in S43, determination is made as to whether reception of the mail data is completed based on a transfer completion signal, which is included in the mail data to indicate completion of transferring the mail data. As the transfer completion signal is received, determination is made that reception of the mail data is completed (S43:YES). The process thereafter returns to S41. In S43, when the transfer completion signal is not received, determination is made that reception of the mail data is incomplete (S43: NO). Next, in S44, error information indicating that the mail data cannot be transmitted to the PC 22A is generated and transmitted to the internet facsimile machine 21 via the connection cable 24.

The process returns to S31 of the data transfer process shown in FIG. 5. In S31, when the error information from the mail server 23 is not received by the internet facsimile machine 21(S31: NO), determination is made that the entire mail data from the employee α is transmitted to the mail server 23. The process returns to S22. The mail data from the employee α to the employee β is thus stored in the mail server 23 until the employee β operates the PC 22A to inquire the mail server for any mail data.

In S31, when the error information from the mail server 23 is received by the internet facsimile machine 21 (S31: YES), determination is made that the entire mail data is not transmitted to the mail server 23, thus the mail data cannot be transferred to the PC 22A of the employee β. Next, in S32, an error message mail as return mail data is generated. More specifically, the message data is removed from the mail data, and the sender address contained in the mail data is set as a new destination address. Further, an error message indicating transferring the mail data to the employee β has failed is appended to the return mail data. Thereafter, in S33, the return mail data as the error message mail addressed to the employee α is transmitted via the Internet 80. The process returns to S22.

Hereinafter, specific functions of the network system 1 will be described. As the employee α of the company A sends the mail, the mail data of the mail can be transmitted to the employee β of the company B from the internet facsimile machine 11 via the public telecommunication line 90 and via the Internet 80.

In the internet facsimile machine 11, software program for encryption and configuring passwords is not installed due to frequency of use and for cost-reduction purpose, and the mail data transmitted from the internet facsimile machine 11 is not encrypted or set a password. When the employee α transmits the mail data containing confidential information via the Internet 80, the confidential information may be undesirably accessed through mail servers provided on the Internet 90. Therefore, the employee α may wish to transmit the confidential information to the employee β via the public telecommunication line 90.

The employee β, on the other hand, wishes to receive the confidential information in mail data via the Internet 90 so that the mail data can be used for data processing and clerical efficiency purpose. Thus, it is not adequate that the employee α transmits the confidential information printed on recording paper via the public telecommunication line 90.

In this case, the employee α can transmit the confidential information included in mail data from the internet facsimile machine 11 to the employee β via the public telecommunication line 90. The internet facsimile machine 11 calls the internet facsimile machine 21 of the company B via the public telecommunication line 90 to establish connection with the internet facsimile machine 21 of the company B (see S5 in FIG. 4). When the connection is established, the internet facsimile machine 11 attempts to establish communication with the internet facsimile machine 21, and determination is made as to whether the internet facsimile machine 21 is ready to receive the mail data from the internet facsimile machine 11 (S6, S7 in FIG. 4). After the communication between the internet facsimile machine 11 and the internet facsimile machine 21 is established on one-to-one basis, the internet facsimile machine 11 transmits the mail data with the confidential information to the internet facsimile machine 21 (S7: YES, S11 in FIG. 4). Thus, the confidential information included in the mail data is less likely to be undesirably copied and falsified on the public telecommunication line 90. It should be noted that the internet facsimile machines 11, 21 are conventionally connected to the public telecommunication line 90, so that no additional communication line for transmitting the mail data directly from the internet facsimile machine 11 to the internet facsimile machine 21 is necessary.

When the communication between the internet facsimile machine 11 and the internet facsimile machine 21 is established (S22: YES, S23, S24: YES in FIG. 5), the mail data received in the internet facsimile machine 21 is converted by the modem 241 to be stored in the HDD 235 (S26, S27: YES in FIG. 5). Thereafter, the internet facsimile machine 21 is disconnected from the public telecommunication line 90 (S29 in FIG. 5), and thereby the public telecommunication line 90 is released from the internet facsimile machines 11, 21. The internet facsimile machine 21 stores the mail data in the HDD 65 of the mail server 23 according to the destination address included in the mail data (S30, S31: NO in FIG. 5) so that the mail data can be transferred to the PC 22A of the employee β as the employee β operates the PC 22A to inquire the mail server for any mail data. As the internet facsimile machine 21 and the PC 22A are connected via the intranet 20 to be internally communicable, the mail data received in the internet facsimile machine 21 can be securely delivered to the PC 22A.

As described above, with the network system 1 according to the first embodiment, security of the mail data transmitted from the internet facsimile machine 11 to the internet facsimile machine 21 can be cost-effectively achieved in a less complicated manner. More specifically, the configuration of the existing internet facsimile machine 21 does not require changes in order to, for example, configure the internet facsimile machine 21 such that the mail data transmitted thereto can be secured, while cost for communication and transmission is maintained lower. That is, the internet facsimile machine 21 does not require an interface to receive facsimile data and an interface to decrypt the data received via the Internet 80. Further, software to configure the encrypting process and passwords is not required to be stored in the internet facsimile machine 21. Furthermore, administration of the passwords is unnecessary.

In the network system 1 of the first embodiment, the mail server 23 is internally communicably connected with the internet facsimile machine 21 and the PC 22A via the connection cable 24. With this configuration, the mail data transmitted by the employee α received in the internet facsimile machine 21 is temporarily stored in the mail server 23 so that the mail data including the destination address can be delivered from the mail server 23 to the PC 22A of the employee β when the employee β operates the PC 22A to inquire the mail server 23 for mail data. Therefore, the internet facsimile machine 21 is not required to store a large amount of mail data therein when the large amount of mail data is transmitted. It should be noted that providing the mail server 23 separately from the internet facsimile machine 21 is specifically advantageous when the internet facsimile machine 21 is a machine in a lower grade having a small amount of memory device. Further, the employee β can inquire the mail server 23 for the mail data via the PC 22A whenever convenient to obtain the mail data including the confidential information from the employee α and use the mail data in the PC 22A and other PCs. It should be noted, as the mail data transmitted via the Internet 80 is received by the mail server 23, a capable amount to store the mail data in the internet facsimile machine 11 can be configured to be small, while the memory devices (i.e., the ROM 223, the HDD 235) of the internet facsimile machine 21 can be prevented from receiving excessive amount of mail data.

Further, in the network system 1 of the first embodiment, the mail server 23 transmits the error information to the internet facsimile machine 21 when transferring the mail data from the internet facsimile machine 21 to the PC 22A fails (S41, S42: YES, S43: NO, S44 in FIG. 6, and S31: YES in FIG. 5), while the internet facsimile machine 21 that receives the error information creates the error message mail as the return mail data by removing the message data that may include the confidential information and replacing the removed message data with the error message. The error message mail is returned to the internet facsimile machine 11 of the company A via the Internet 80 (S32, S33 in FIG. 5). As the message data is replaced with the error message in the error message mail, the confidential information included in the original mail data cannot be accessed undesirably. Further, the error message mail delivered to the employee α includes the data that the employee α originally created (such as the title data and the destination address) but excludes the message data that may include the confidential information, therefore, the employee α can easily recognize the mail data that has failed to be delivered to the employee β by viewing the error message mail. Thus, the employee α can be notified of the failure of the delivery while the confidential information is prevented from leakage.

In the network system 1 of the first embodiment, the internet facsimile machine 21 obtains the domain address of the destination address from the mail data stored in the HDD 235 so that the internet facsimile machine 21 determines as to whether the domain address of the destination address corresponds to the domain address of the internet facsimile machine 21 itself (S23, S24 in FIG. 5). When the two domain addresses correspond, it is determined that the PCs 22A, 22B corresponding to the destination address exists in the intranet 20 so that the communication between the internet facsimile machine 11 and the internet facsimile machine 22 is established and the mail data is transferred (S24: YES, S26, S27: YES, S29, S30 in FIG. 5). When the two domain addresses do not correspond, it is determined that the PCs 22A, 22B corresponding to the domain address of the destination address do not exist in the intranet 20, therefore the internet facsimile machine 21 is not in communication with the internet facsimile machine 11. In this state, the internet facsimile machine 21 cannot transfer the mail data to either of the PCs 22A, 22B, and the line is disconnected so that the mail data is prohibited from being transferred to the PC 22A (S24: NO, S25 in FIG. 5). Therefore, in the network system 1 of the first embodiment, the mail data can be prevented from being transferred to the PCs 22a, 22B improperly so that the security for transmitting the mail data that may include the confidential information can be improved.

Further, in the internet facsimile machine 21 of the first embodiment, the modem 241 converts the mail data transmitted via the public telecommunication line 90 into suitable data to be stored in the RAM 34 so that the converted mail data is transferred to the PC 22A of the employee β via the intranet 20 (S26, S27: YES, S29, S30, S31: YES). The internet facsimile machine 21 of the company B receives the mail data with the internet facsimile machine 11 connected to the internet facsimile machine 21 on one-to-one basis via the public telecommunication line 90 and transfers the mail data to the PC 22a which is the destination via the intranet 20. Therefore, the mail data including the confidential information can be transmitted securely to the PC 22A even if the internet facsimile machine 21 is not required to store an encrypting software program, and the company B is not required to configure passwords and encryption setting in the internet facsimile machine 21. Thus, with the network system 1 according to the first embodiment, security of the mail data transmitted from the internet facsimile machine 11 to the internet facsimile machine 21 can be cost-effectively achieved in a less complicated manner.

In the internet facsimile machine 11 of the first embodiment, the mail address that specifies the PC 22A of the employee β and the telephone number of the internet facsimile machine 21 are associated with each other to be stored in the nonvolatile RAM 38 (see FIG. 3). Thus, when the mail address of the employee β is specified as the destination address, the mail address of the employee β is referred to the mail address stored in the nonvolatile RAM 38 to obtain the telephone number assigned to the internet facsimile machine 21 of the company B so that the mail data can be transmitted to the PC 22A via the internet facsimile machine 21 (see S5 in FIG. 4). Therefore, the employee α can send the mail data to the PC 22A via the internet facsimile machine 21 as the internet facsimile machine 11 is connected to the internet facsimile machine 21 via the public telecommunication line 90 securely on one-to-one basis without being required to input the telephone number of the internet facsimile machine 21. Thus, with the network system 1 according to the first embodiment, security of the mail data transmitted can be cost-effectively achieved in a less complicated manner.

Furthermore, the internet facsimile machine 11 of the company A is connected to the PC 22A of the employee β via the Internet 80. Therefore, when the mail data transmitted from the employee α to the employee β is confidential mail data including confidential information, the mail data can be delivered to the PC 22A via the public telecommunication line 90 and the internet facsimile machine 21. When the mail data transmitted from the employee α to the employee β is normal mail data including no specific confidential information, the mail data is delivered to the PC 22A via the Internet 80 but not through the internet facsimile machine 21 (S1-S3 in FIG. 4). Therefore, an amount of the mail data to be transferred from the internet facsimile machine 21 can be reduced so that communication load on the internet facsimile machine 21 can be reduced.

In the first embodiment described above, the mail server 23 is provided independently from the internet facsimile machine 21. It may be advantageous to provide the mail server 23 independently from the internet facsimile machine 21 when an amount of the mail data to be received by the mail server 23 is substantially large so that a large volume of memory area can be maintained in the network system 1. However, when the amount of the mail data to be received by the mail server 23 is small, providing the mail server 23 independently from the internet facsimile machine 21 can be disadvantage in cost-effectiveness.

Hereinafter, a network system 81 according to a second embodiment of the invention will be described. In the second embodiment, an internet facsimile machine 83 is provided with a function to operate as a server. It should be noted that in the second embodiment components of the network system 81 in similar configurations to those in the network system 1 of the first embodiment are provided with reference numerals that are similar to the reference numerals of the corresponding components of the network system 1, and description of the components is omitted.

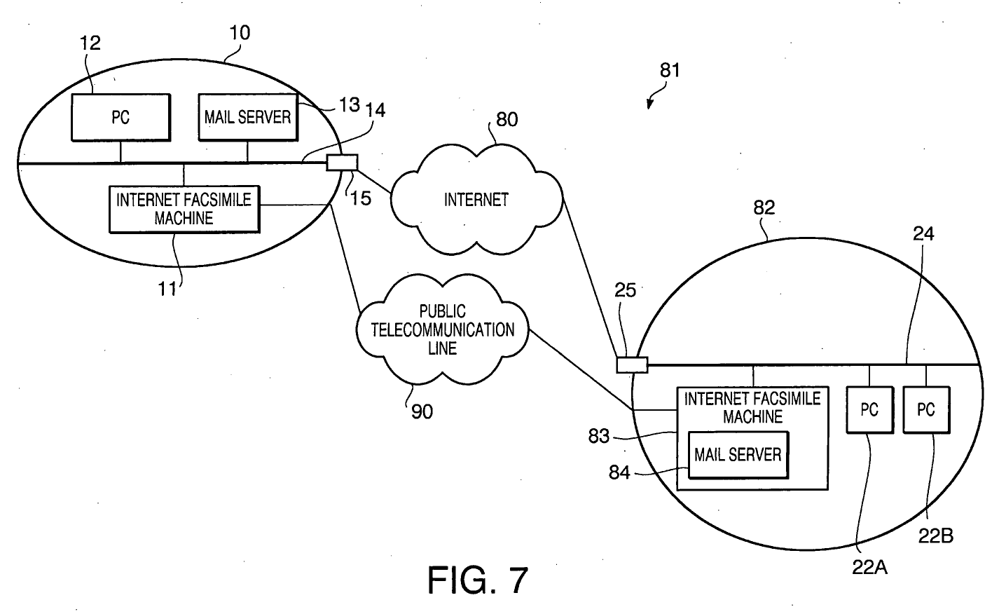

A configuration of a network system 81 according to the second embodiment will be described. FIG. 7 shows a diagram to illustrate the network system 81 according to the second embodiment of the invention. In the network system 81, the internet facsimile machine 83 with a mail server 84 is connected with an intranet 82. The internet facsimile machine 83 is connected with the internet facsimile machine 11 via the public telecommunication line 90. As the mail data is transmitted, the internet facsimile machine 83 stores the mail data in the mail server 84 so that the mail data having a destination address that corresponds to the mail address of the PC 22A can be internally transferred to the PC 22A via the intranet 82 when the PCs 22A, 22B inquire the mail server 84 for mail data.

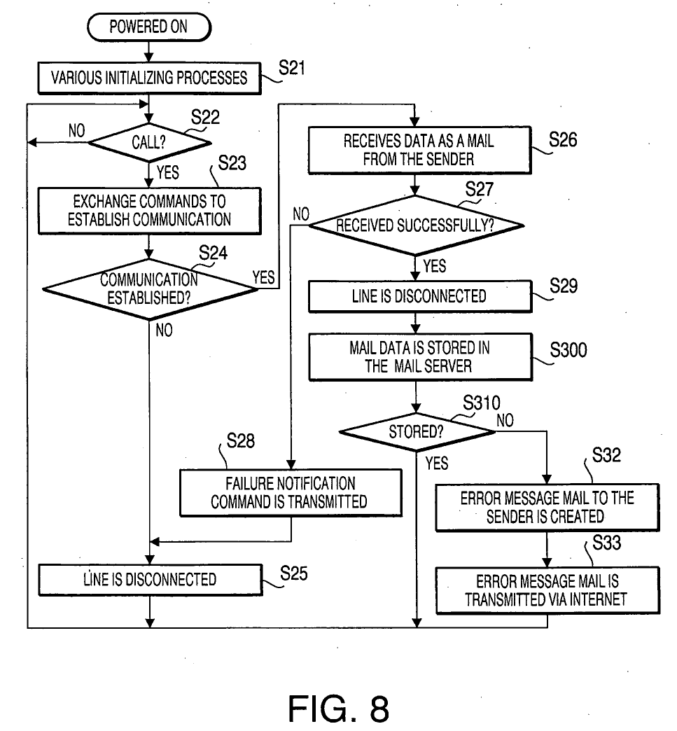

Hereinafter, data transfer process in the network system 81 of the second embodiment will be described. FIG. 8 shows a flowchart to illustrate the data transfer process in the network system 81 according to the second embodiment of the invention. The data transfer process executed by the internet facsimile machine 83 is generally similar to the data transfer process executed by the internet facsimile machine 21 of the first embodiment, however, S30 and S31 are replaced with S300 and S310 respectively. As the internet facsimile machine 83 receives the mail data (S27), and the public telecommunication line 90 is disconnected (S29), in S300, the received mail data is stored in the mail server 84 without transferring through the connection cable 24. Thereafter, in S310, determination is made as to whether the mail data is stored in the mail server 84. When the mail data is stored in the mail server 84(S310:YES), the process returns to S22. When the mail data is not stored in the mail server 84(S310:NO), the process proceeds to S32. Thereafter, the process proceeds from S32 to S33 as described above in the description of the first embodiment.

Hereinafter, specific functions of the network system 81 will be described. The internet facsimile machine 83 of the network system 81 includes a function as a server. Therefore, when the mail data is internally transmitted to the PC 22A via the intranet 82, the mail data to be received by the PC 22A can be processed within the internet facsimile machine 83 so that the network system 81 can be configured to be downsized. In other words, the mail server 23 in the first embodiment is not necessarily required so that the network system 81 can be configured at a lower cost.

Further, in the network system 81 of the second embodiment, the LAN I/F 32 of the internet facsimile machine 83 connects the internet facsimile machine 83 with the Internet 80 via the connection cable 24. As the internet facsimile machine 83 fails in transferring the mail data to the PC 22A, the error message mail as return mail data wherein the message data is removed from the mail data and replaced with the error message is created so that the error message mail is returned to the internet facsimile machine 11 at the sender side via the Internet 90 (S31: NO, S32, S33 in FIG. 8). Thus, the sender of the mail data can be notified of the failure in transmission while the message included in the mail data can be prevented from leakage.

Although examples of carrying out the invention have been described, those skilled in the art will appreciate that there are numerous variations and permutations of the network system that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, the internet facsimile machines 21, 83 as data processing devices can be replaced with a printing device and a facsimile machine having an AT modem and a data transferring function.

For another example, a number of the intranets connected with the Internet 80 and the public telecommunication line 90 is not limited to two, but may be more than two. Further, the network system may include a plurality of LANs connected with the Internet 80 and the public telecommunication line 90 to configure a wide area network system. Furthermore, the network system may include one or more of a wireless LAN, a wired LAN, an intranet, and a standalone terminal devices that are connected with the Internet 80 and the public telecommunication line 90 to configure a wide area network system. Furthermore, a network wherein various devices are internally communicably connected can be connected to a different network via the Internet 80 and the public telecommunication line 90 to configure a wide area network system.

In the embodiments described above, the mail data created in the internet facsimile machine 11 is transmitted to the PC 22A. However, for example, the mail transmission program 70 may be stored in the PC 12 so that the mail data including for example message data and confidentiality information created in a terminal device (the PC 12) can be transmitted to the PC 22A. Further, the mail data can be transmitted in another direction, i.e., from the intranet 20 to the intranet 10, for example.

In the embodiments described above, the internet facsimile machines 11, 21, 83 an the PCs 12, 22A, 22B are employed as terminal devices, however, the terminal devices may be a mobile phone and a portable computer.

Further, in the embodiments described above, the mail transmission program 70 is stored in the internet facsimile machine 11 as the sender, and the mail transfer program 42 is stored in the internet facsimile machine 21 as the destination, although the mail transmission program 70 may be stored in the internet facsimile machine 21 and the mail transfer program 42 may be stored in the internet facsimile machine 11. Furthermore, both of the mail transmission program 70 and the mail transfer program 42 may be stored in the internet facsimile machine 11 and internet facsimile machine 21 respectively.

What is claimed is:

1. A network system comprising;
a data processing device with a communication circuit connected to a telecommunication line; and
a communication device internally communicably connected to the data processing device via a network,
wherein the data processing device is provided with:
a receiver system to receive mail data transmitted from a data transmitting device via the communication circuit; and
a transferring system to internally communicate with the communication device to transfer the mail data transmitted from the receiver system to the communication device via the network.

2. The network system according to claim 1, further comprising a mail server which is internally communicably connected with the data processing device and the communication device via the network,
wherein the transferring system transfers the mail data to the communication device via the mail server.

3. The network system according to claim 2,
wherein the mail server is provided with a transmission system which transmits error information to the data processing device when the transferring system fails in transferring the mail data to the communication device,
wherein the data processing device is provided with:
a network interface, which connects the data processing device with the Internet;
a return data generating system, which generates return mail data by removing message data from the mail data received by the receiver system and adding an error notifying message when the error information is received by the data processing device; and
a returning system, which returns the return mail data generated by the return data generating system to the data transmitting device that transmitted the mail device via the Internet.

4. The network system according to claim 1,
wherein the receiver system is provided with a function as a mail server, and
wherein the transferring system transfers the mail data transmitted from the receiver system to the communication device via the network.

5. The network system according to claim 4,
wherein the data processing device is provided with: a network interface, which connects the data processing device with the Internet;
a return data generating system, which generate return mail data by removing message data from the mail data received by the receiver system and adding an error notifying message when the transferring system fails in transferring the mail data to the communication device; and
a returning system, which returns the return mail data generated by the return data generating system to the data transmitting device that transmitted the mail device via the Internet.

6. The network system according to claim 1,
wherein the data processing device is provided with:
a domain address storing unit, in which a domain address of the data processing device is stored;
a judging system, which obtains a domain address of the communication device as a destination from the mail data received by the receiver system and determines as to whether the domain address of the communication device as the destination corresponds to the domain address of the data processing device stored in the domain address storing unit; and
a prohibiting system, which prohibits the transferring system to transfer the mail data to the communication device when the judging system determines that the domain address of the communication device as the destination does not correspond to the domain address of the data processing device.

7. The network system according to claim 4,
wherein the data processing device is provided with:
a domain address storing unit, in which a domain address of the data processing device is stored;
a judging system, which obtains a domain address of the communication device as a destination from the mail data received by the receiver system and determines as to whether the domain address of the communication device as the destination corresponds to the domain address of the data processing device stored in the domain address storing unit; and
a prohibiting system, which prohibits the transferring system to transfer the mail data to the communication device when the judging system determines that the domain address of the communication device as the destination does not correspond to the domain address of the data processing device.

8. A data processing device connected to a communication device via a network, comprising:
a communication circuit, which is connected to a telecommunication line and converts data;
a receiver system, which receives mail data transmitted from a data transmitting device via the communication circuit; and
a transferring system, which internally communicates with the communication device to transfer the mail data transmitted from the receiver system to the communication device via the network.

9. A data transmitting device, comprising:
a storing unit, in which a mail address identifying a communication device as a destination of mail data and a number sequence identifying a data processing device whereto the mail data is transmitted via a telecommunication line are associated with each other to be stored therein;
a specifying system, wherein the mail address as the destination to transmit the mail data is specified;
a number sequence obtaining system, which obtains the number sequence corresponding to the mail address specified in the specifying system; and
a mail data transmission system, which transmits the mail data to the communication device via the data processing device being identified by the number sequence obtained by the number sequence obtaining system.

10. The data transmitting device according to claim 9, further comprising:
a confidentiality specifying system, which is communicable with the communication device via the Internet and in which confidentiality of the mail data is specified,
wherein the mail data transmission system transmits the mail data to the communication device via the data processing device when the mail data is specified to contain confidential information in the confidentiality specifying system and transmits the mail data to the communication device via the Internet when the mail data is specified not to contain confidential information in the confidentiality specifying system.
